(19) United States
(12) Patent Application Publication
(10) Pub. No.: US 2022/0229789 A1
(43) Pub. Date: Jul. 21, 2022

(54) Host Memory Buffer (HMB) Abstraction Protocol Layer

(71) Applicant: Western Digital Technologies, Inc., San Jose, CA (US)

(72) Inventors: Rakesh Balakrishnan, Bangalore (IN); Yuvaraj Kumar, Bangalore (IN); Chandramani, Bangalore (IN)

(21) Appl. No.: 17/181,383

(22) Filed: Feb. 22, 2021

Related U.S. Application Data
(60) Provisional application No. 63/140,091, filed on Jan. 21, 2021.

(51) Int. Cl. G06F 13/16; G06F 13/42; G06F 12/1009

(52) U.S. Cl. CPC G06F 13/1673; G06F 13/4282; G06F 2212/657; G06F 2213/0026; G06F 12/1009

(57) ABSTRACT

A Host Memory Buffer (HMB) Abstraction Protocol layer is individually included in a host device and a SD-PCIe device. The HMB Abstraction Protocol layers provide the SD-PCIe device access to a HMB region of the host device when the SD-PCIe is operating in the SD mode, where the HMB region was previously inaccessible to the SD-PCIe device when operating in the SD mode.

### CROSS-REFERENCE TO RELATED APPLICATION

This application claims priority to and the benefit of U.S. Provisional Patent Application No. 63/140,091, filed on Jan. 21, 2021, the entire contents of which is incorporated herein by reference.

### FIELD

This application relates generally to data storage devices and, more particularly, to respective HMB abstraction protocol layers in host devices and data storage devices.

### BACKGROUND

Typically, Non-Volatile Memory Express (NVMe) devices support a HMB feature. The HMB feature provides a mechanism for a host device to allocate a portion of memory (e.g., dynamic random access memory also referred to as “DRAM”) in the host device for exclusive use by a device controller in NVMe devices. The device controller may use the HMB feature to store any of the device controller's firmware (FW) control data, which helps to improve the performance of the device controller, and in some examples, the endurance of non-volatile memory in the NVMe device. The firmware control data may include the mapping tables that convert logical memory addresses to physical memory locations, command queue information, or other control data.

### SUMMARY

Unlike NVMe devices, which are single-mode devices, multi-mode devices may support both Secure Digital (SD) and NVMe protocols. One example of a multi-mode device is a SD-PCIe device that is operational in both a NVMe mode and a SD mode, where the SD-PCIe device may be initialized in any host mode (i.e., the SD mode or the NVMe mode). However, multi-mode devices may include other devices that also support both SD and NVMe protocols and are not limited to only a SD-PCIe device, which is described herein for ease of understanding.

Typically, HMB information cannot be accessed by a device controller operating in the SD mode. As the HMB information was typically inaccessible, the host device would flush the content in the HMB to prevent data loss when the host device switched from operating in the NVMe mode to operating in the SD mode. The flushing of the content in the HMB added overhead in the host device's switching from the NVMe mode to the SD mode. However, the host device of the disclosure does not need to flush of the updated content in the HMB. Instead, as described herein, the host device of the disclosure may transition the HMB information to the SD mode. Additionally, the transitioning of the HMB information to the SD mode allows the data storage device to access the HMB in the SD mode where the HMB was previously inaccessible.

As described in greater detail below, respective HMB Abstraction Protocol layers may be included in a host device and in a SD-PCIe device, which provides the SD-PCIe device access to the HMB region of the host device in either the NVMe mode or the SD mode of the SD-PCIe device. The respective HMB Abstraction Protocol layers are program code (e.g., firmware, software, or other program code) that provide one or more application programming interface (APIs) between the host device and the SD-PCIe device, which allows access to the HMB region of the host device when the SD-PCIe device is in the SD mode. Further, while dynamic switching from the NVMe mode to the SD mode has an additional step of transitioning the HMB information to a SD command layer, the host device may transition the HMB information to the SD mode without flushing the updated content in the HMB.

The disclosure provides a data storage device controller including, in one embodiment, memory and an electronic processor communicatively coupled to the memory. The memory includes a SD HMB dataset and a HMB Abstraction Protocol layer that maintains the SD HMB dataset.

The disclosure also provides a first method. In one embodiment, the first method includes receiving, with a data storage device controller operating in a SD mode, one or more vendor specific commands from a host device. The first method also includes determining, with the data storage device controller operating in the SD mode and executing a HMB Abstraction Protocol layer, whether the host device has initialized a HMB from the one or more vendor specific commands.

The disclosure provides a host device including, in one embodiment, memory and an electronic processor communicatively coupled to the memory. The memory includes a NVMe Host Software, and a SD Host Software with a HMB Abstraction Protocol layer.

The disclosure also provides a second method. In one embodiment, the second method includes querying, with an electronic processor of a host device executing a SD Host Software with a HMB Abstraction Protocol layer, a NVMe Host Software for a HMB descriptor list that is a list of host memory address ranges of a HMB for exclusive use by a data storage device controller. The second method includes receiving, with the electronic processor, the HMB descriptor list from the NVMe Host Software. The second method includes generating, with the electronic processor, one or more vendor specific commands based on the HMB descriptor list that is received. The second method also includes sending, with the electronic processor, the one or more vendor specific commands to the data storage device controller.

The disclosure provides a first apparatus including, in one embodiment, means for receiving one or more vendor specific commands from a host device and means for determining whether the host device has initialized a HMB from the one or more vendor specific commands.

The disclosure provides a second apparatus including, in one embodiment, means for querying a NVMe Host Software for a HMB descriptor list that is a list of host memory address ranges of a HMB for exclusive use by a data storage device controller. The second apparatus includes means for receiving the HMB descriptor list from the NVMe Host Software. The second apparatus includes means for generating one or more vendor specific commands based on the HMB descriptor list that is received. The second apparatus also includes means for sending the one or more vendor specific commands to the data storage device controller.

The disclosure also provides a system including in one embodiment, a data storage device controller of the disclosure and a host device of the disclosure.

In this manner, various aspects of the disclosure provide for improvements in at least the technical fields of data storage devices and their design and architecture. The disclosure can be embodied in various forms, including hardware or circuits controlled by firmware or software (i.e., program code executing on a processor), computer systems and networks, user interfaces, and application programming interfaces; as well as hardware-implemented methods, signal processing circuits, memory arrays, application specific integrated circuits, field programmable gate arrays, and the like. The foregoing summary is intended solely to give a general idea of various aspects of the disclosure, and the foregoing summary does not limit the scope of the disclosure in any way.

### BRIEF DESCRIPTION OF THE DRAWINGS

FIG. 1 is block diagram of a system including a data storage device and a host device with respective HMB Abstraction Protocol layers, in accordance with some embodiments of the disclosure.

FIG. 2 is a block diagram illustrating an initialization of a NVMe mode of the data storage device of FIG. 1, in accordance with various aspects of the disclosure.

FIG. 3 is a block diagram illustrating normal operations of the NVMe mode of the data storage device of FIG. 1, in accordance with various aspects of the disclosure.

FIG. 4 is a block diagram illustrating an initialization of a SD mode of the data storage device of FIG. 1, in accordance with various aspects of the disclosure.

FIG. 5 is a block diagram illustrating normal operations of the SD mode of the data storage device of FIG. 1 using the respective HMB Abstraction Protocol layers of FIG. 1, in accordance with various aspects of the disclosure.

FIG. 6 is a block diagram illustrating a working example of the SD mode of FIG. 5 of the data storage device of FIG. 1 using the respective HMB Abstraction Protocol layers of FIG. 1, in accordance with various aspects of the disclosure.

FIG. 7 is a flowchart illustrating an example method of operating the data storage device of FIG. 1, in accordance with some embodiments of the disclosure.

FIG. 8 is a flowchart illustrating an example method of operating the host device of FIG. 1, in accordance with some embodiments of the disclosure.

### DETAILED DESCRIPTION

In the following description, numerous details are set forth, such as data storage device configurations, controller operations, and the like, in order to provide an understanding of one or more aspects of the disclosure. It will be readily apparent to one skilled in the art that these specific details are merely exemplary and not intended to limit the scope of this application. In particular, the functions associated with the host device and/or the data storage device may be performed by hardware (e.g., analog or digital circuits), a combination of hardware and software (e.g., program code or firmware stored in a non-transitory computer-readable medium that is executed by processing or control circuitry), or any other suitable means. The following description is intended solely to give a general idea of various aspects of the disclosure, and the following description does not limit the scope of the disclosure in any way.

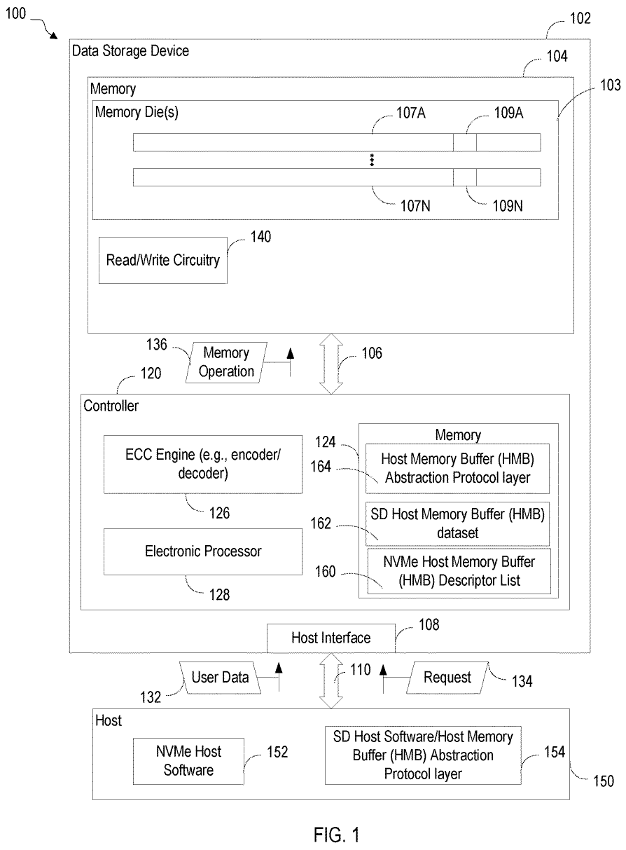

FIG. 1 is block diagram of a system including a data storage device and a host device with respective HMB Abstraction Protocol layers, in accordance with some embodiments of the disclosure. In the example of FIG. 1, the system 100 includes a data storage device 102 and a host device 150. The data storage device 102 includes a controller 120 (referred to hereinafter as “data storage device controller”) and a memory 104 (e.g., non-volatile memory) that is coupled to the data storage device controller 120.

One example of the structural and functional features provided by the data storage device controller 120 are illustrated in FIG. 1 in a simplified form. One skilled in the art would also recognize that the data storage device controller 120 may include additional modules or components other than those specifically illustrated in FIG. 1. Additionally, although the data storage device 102 is illustrated in FIG. 1 as including the data storage device controller 120, in other implementations, the data storage device controller 120 is instead located separate from the data storage device 102. As a result, operations that would normally be performed by the data storage device controller 120 described herein may be performed by another device that connects to the data storage device 102.

The data storage device 102 and the host device 150 may be operationally coupled via a connection (e.g., a communication path 110), such as a bus or a wireless connection. In some examples, the data storage device 102 may be embedded within the host device 150. Alternatively, in other examples, the data storage device 102 may be removable from the host device 150 (i.e., “removably” coupled to the host device 150). As an example, the data storage device 102 may be removably coupled to the host device 150 in accordance with a removable universal serial bus (USB) configuration. In some implementations, the data storage device 102 may include or correspond to a solid state drive (SSD), which may be used as an embedded storage drive (e.g., a mobile embedded storage drive), an enterprise storage drive (ESD), a client storage device, or a cloud storage drive, or other suitable storage drives.

The data storage device 102 may be configured to be coupled to the host device 150 via the communication path 110, such as a wired communication path and/or a wireless communication path. For example, the data storage device 102 may include an interface 108 (e.g., a host interface) that enables communication via the communication path 110 between the data storage device 102 and the host device 150, such as when the interface 108 is communicatively coupled to the host device 150.

The host device 150 may include an electronic processor and a memory. The memory may be configured to store data and/or instructions that may be executable by the electronic processor. The memory may be a single memory or may include one or more memories, such as one or more non-volatile memories, one or more volatile memories, or a combination thereof. The host device 150 may issue one or more commands to the data storage device 102, such as one or more requests to erase data at, read data from, or write data to the memory 104 of the data storage device 102. Additionally, the host device 150 may issue one or more vendor specific commands to the data storage device 102 to notify and/or configure the data storage device 102 to access a HMB when the data storage device 102 is in a SD mode. For example, the host device 150 may be configured to provide data, such as user data 132, to be stored at the memory 104 or to request data to be read from the memory 104. The host device 150 may include a mobile smartphone, a music player, a video player, a gaming console, an electronic book reader, a personal digital assistant (PDA), a computer, such as a laptop computer or notebook computer, any combination thereof, or other suitable electronic device.

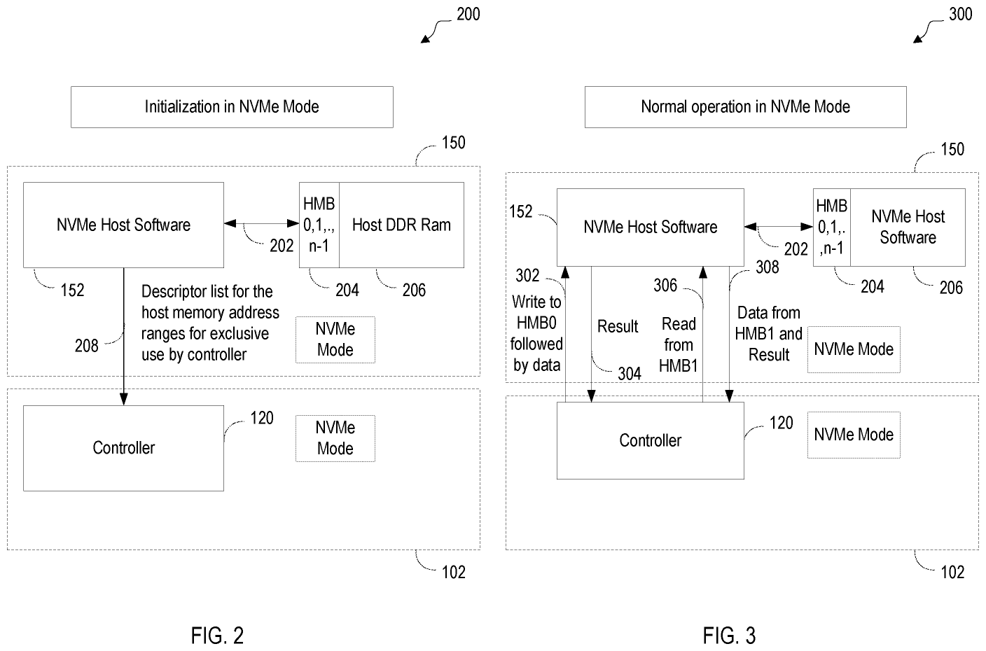

The host device 150 communicates via a memory interface that enables reading from the memory 104 and writing to the memory 104. The host device 150 operates in compliance with one or more industry specifications including the NVMe Host Controller specification and the SD Host Controller specification. In particular, the host device 150 includes a NVMe Host Software 152 that the electronic processor of the host device 150 executes to operate in compliance with the NVMe Host Controller specification. The NVMe Host Software 152 is part of the software on the host device 150, and the software on the host device 150 includes application software, system software, programming software, driver software, and/or any other suitable software. In some examples, the NVMe Host Software 152 may be one or more drivers that are part of the driver software on the host device 150. The functions performed by the electronic processor of the host device 150 executing the NVMe Host Software 152 are described in greater detail below with respect to FIGS. 2-6.

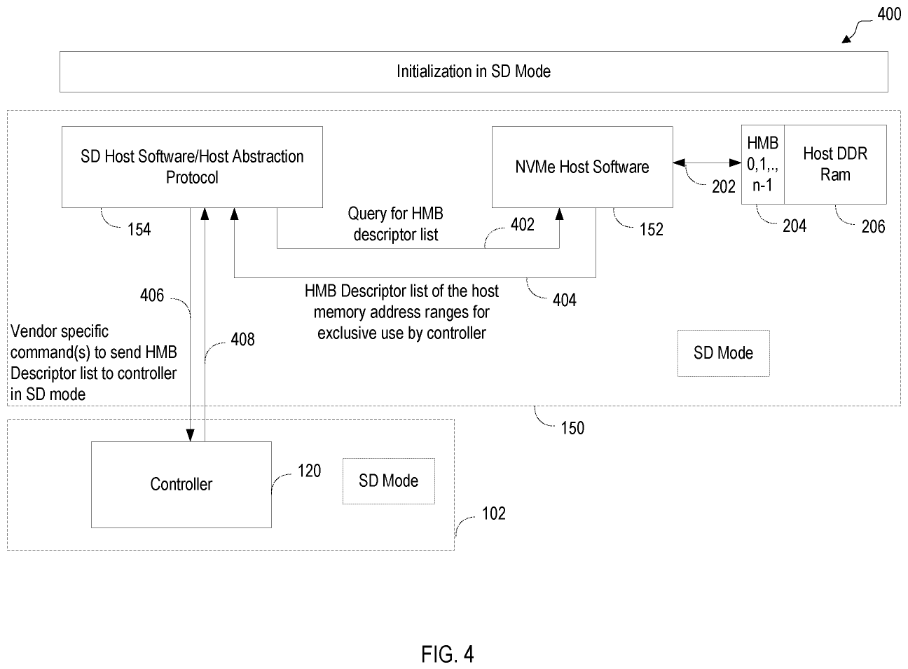

The host device 150 also includes a SD Host Software/HMB Abstraction Protocol layer 154 that the electronic processor of the host device 150 executes to operate in compliance with the SD Host Controller specification. The SD Host Software/HMB Abstraction Protocol layer 154 is also part of the software in the host device 150. In some examples, the SD Host Software/HMB Abstraction Protocol layer 154 may be one or more drivers that are part of the driver software on the host device 150. Additionally, the SD Host Software/HMB Abstraction Protocol layer 154 provides seamless access to buffers of a HMB feature associated with the NVMe Host Controller specification in the SD mode of the data storage device 102 by providing a translation service (e.g., one or more APIs) between the NVMe host software 152 and the firmware of the data storage device controller 120. The functions performed by the electronic processor of the host device 150 executing the SD Host Software/HMB Abstraction Protocol layer 154 are described in greater detail below with respect to FIGS. 4-6.

In other examples, the host device 150 may operate in compliance with other specifications, such as a Universal Flash Storage (UFS) Host Controller Interface specification, a Universal Serial Bus specification, or other suitable industry specification. The host device 150 may also communicate with the memory 104 in accordance with any other suitable communication protocol.

The memory 104 of the data storage device 102 may include a non-volatile memory (e.g., NAND, 3D NAND family of memories, or other suitable memory). In some examples, the memory 104 may be any type of flash memory. For example, the memory 104 may be two-dimensional (2D) memory or three-dimensional (3D) flash memory. The memory 104 may include one or more memory dies 103. Each of the one or more memory dies 103 may include one or more blocks (e.g., one or more erase blocks). Each block may include one or more groups of storage elements, such as a representative group of storage elements 107A-107N. The group of storage elements 107A-107N may be configured as a word line. The group of storage elements 107 may include multiple storage elements (e.g., memory cells that are referred to herein as a “string”), such as a representative storage elements 109A and 109N, respectively.

The memory 104 may include support circuitry, such as read/write circuitry 140, to support operation of the one or more memory dies 103. Although depicted as a single component, the read/write circuitry 140 may be divided into separate components of the memory 104, such as read circuitry and write circuitry. The read/write circuitry 140 may be external to the one or more memory dies 103 of the memory 104. Alternatively, one or more individual memory dies may include corresponding read/write circuitry that is operable to read from and/or write to storage elements within the individual memory die independent of any other read and/or write operations at any of the other memory dies.

The data storage device 102 includes the data storage device controller 120 coupled to the memory 104 (e.g., the one or more memory dies 103) via a bus 106, an interface (e.g., interface circuitry), another structure, or a combination thereof. For example, the bus 106 may include multiple distinct channels to enable the data storage device controller 120 to communicate with each of the one or more memory dies 103 in parallel with, and independently of, communication with the other memory dies 103. In some implementations, the memory 104 may be a flash memory.

The data storage device controller 120 is configured to receive data and instructions from the host device 150 and to send data to the host device 150. For example, the data storage device controller 120 may send data to the host device 150 via the interface 108, and the data storage device controller 120 may receive data from the host device 150 via the interface 108. The data storage device controller 120 is configured to send data and commands (e.g., the memory operation 136) to the memory 104 and to receive data from the memory 104. For example, the data storage device controller 120 is configured to send data and a write command to cause the memory 104 to store data to a specified address of the memory 104. The write command may specify a physical address of a portion of the memory 104 (e.g., a physical address of a word line of the memory 104) that is to store the data.

The data storage device controller 120 is configured to send a read command to the memory 104 to access data from a specified address of the memory 104. The read command may specify the physical address of a region of the memory 104 (e.g., a physical address of a word line of the memory 104). The data storage device controller 120 may also be configured to send data and commands to the memory 104 associated with background scanning operations, garbage collection operations, and/or wear-leveling operations, or other suitable memory operations.

The data storage device controller 120 may include a memory 124 (for example, a random access memory [“RAM”], a read-only memory [“ROM”], a non-transitory computer readable medium, or a combination thereof), an error correction code (ECC) engine 126, and an electronic processor 128 (for example, a microprocessor, a microcontroller, a field-programmable gate array [“FPGA”] semiconductor, an application specific integrated circuit [“ASIC”], or another suitable programmable device).

The memory 124 stores data and/or instructions that may be executable by the electronic processor 128. For example, the memory 124 may be static RAM (SRAM) that includes a NVMe HMB descriptor list 160, a SD HMB dataset 162, and a HMB Abstraction Protocol layer 164 that is executable by the electronic processor 128.

Additionally, although the data storage device controller 120 is illustrated in FIG. 1 as including the memory 124, in other implementations, some or all of the memory 124 is instead located separate from the data storage device controller 120 and executable by the electronic processor 128 or a different electronic processor that is external to the data storage device controller 120 and/or the data storage device 102. For example, the memory 124 may be dynamic random access memory (DRAM) that is separate and distinct from the data storage device controller 120 and includes some or all of the NVMe HMB descriptor list 160, the SD HMB dataset 162, and the HMB Abstraction Protocol layer 164. As a result, operations that would normally be performed solely by the data storage device controller 120 described herein may be performed by the following: 1) the electronic processor 128 and different memory that is internal to the data storage device 102, 2) the electronic processor 128 and different memory that is external to the data storage device 102, 3) a different electronic processor that is external to the data storage device controller 120 and in communication with memory of the data storage device 102, and 4) a different electronic processor that is external to the data storage device controller 120 and in communication with memory that is external to the data storage device 102.

The NVMe HMB descriptor list 160 is a list of HMB address ranges that are for the exclusive use by the data storage device controller 120. The NVMe HMB descriptor list 160 is initially created during the preceding NVMe mode of the data storage device controller 120 and may be asynchronously updated and stored in the SD HMB dataset 162 when the data storage device controller 120 is operating in the SD mode.

The HMB Abstraction Protocol layer 164 maintains the SD HMB dataset 162 and provides one or more APIs that access or modify the SD HMB dataset 162 based on the vendor specific commands received from the SD Host Software/HMB Abstraction Protocol layer 154 in the host device 150. The SD HMB dataset 162 is a collection of data (e.g., address ranges, control information, or other HMB information) that allows the electronic processor 128 to control a HMB when the data storage device controller 120 is in the SD mode.

In particular, the electronic processor 128 of the data storage device controller 120 implements the one or more APIs of the HMB Abstraction Protocol layer 164 to interpret vendor specific commands sent by the SD Host Software/HMB Abstraction Protocol layer 154. For example, the electronic processor 128 implements the one or more APIs of the HMB Abstraction Protocol layer 164 to extract a HMB descriptor list from the one or more vendor specific commands. The HMB descriptor list is the descriptors that are the host memory buffer address ranges for exclusive use by the data storage device controller 120. Additionally, the electronic processor 128 implements the one or more APIs of the HMB Abstraction Protocol layer 164 to determine a query sent by the SD Host Software/HMB Abstraction Protocol layer 154.

The data storage device controller 120 uses the HMB Abstraction Protocol layer 164 to interface with the SD Host Software/HMB Abstraction Protocol layer 154, and the SD Host Software/HMB Abstraction Protocol layer 154 interfaces with a HMB of the host device 150 via the NVMe Host Software 152. In this way, the respective HMB Abstraction Protocol layer 164 and the SD Host Software/HMB Abstraction Protocol layer 154 provide the data storage device controller 120 access to the HMB of the host device 150 when the data storage device controller 120 and the host device 150 are operating in the SD mode.

The data storage device controller 120 may send the memory operation 136 (e.g., a read command) to the memory 104 to cause the read/write circuitry 140 to sense data stored in a storage element. For example, the data storage device controller 120 may send the read command to the memory 104 in response to receiving a request for read access from the host device 150.

FIG. 2 is a block diagram illustrating an initialization 200 of a NVMe mode of the data storage device 102 of FIG. 1, in accordance with various aspects of the disclosure. As illustrated in FIG. 2, the NVMe host software 152 of the host 150 of FIG. 1 initializes the HMB 204 (including the HMB descriptors) in memory 206 (link 202). After initialization, the NVMe host software 152 communicates the descriptor list to the data storage device controller 120 of the data storage device 102 of FIG. 1 (link 208). The descriptor list is the HMB descriptors that are the host memory address ranges for exclusive use by the data storage device controller 120.

When the data storage device 102 (e.g., a SD-PCIe device) is initialized in NVMe mode (i.e., FIG. 2), the data storage device 102 may use the HMB 204 to cache tables or store any of the device firmware (FW) control data from the data storage device 102 via the NVMe host software 152, which helps to improve the performance and endurance of the data storage device 102.

FIG. 3 is a block diagram illustrating normal operations 300 of the NVMe mode of the data storage device 102 of FIG. 1, in accordance with various aspects of the disclosure. As illustrated in FIG. 2, the data storage device 102 performs the write and read operations to the HMB 204 via register operations initiating transactions with the NVMe host software 152.

Under the normal operations 300 of the NVMe mode, whenever the data storage device controller 120 stores data, for example, control data, tables, or Logical 2 Physical (L2P) mapping table information (e.g., a GAT table) in the HMB 204, the data storage device controller 120 sends a write request. As illustrated in FIG. 3, the data storage device controller 120 sends a write request to the HMB0 to put controller information or some table information, which might be size 4 KB or 8 KB, at one buffer of the HMB buffer index (e.g., HMB0) from the initialized HMB descriptors (link 302). The data storage device controller 120 uses the communication with the NVMe host software 152 to perform a write to the HMB 204 based on the HMB descriptor list (e.g., the NVMe HMB Descriptor list 160) (link 302). The data storage device controller 120 also determines a successful write operation based on the result sent to the data storage device controller 120 from the NVMe host software 152 in response to the write request (link 304).

Under the normal operations 300 of the NVMe mode, whenever the data storage device controller 120 has to access some data, for example, the control data, the tables, or the L2P mapping table information in the HMB 204, the data storage device controller 120 sends a read request (link 306). For example, the data storage device controller 120 submits a read request to read one buffer of the HMB buffer index (e.g., HMB1) from the initialized HMB descriptors. The NVMe software 152 copies the data from the actual location of the HMB 204 and sends the data to the data storage device controller 120 along with a result of the read operation (link 308).

Typically, when a conventional SD-PCIe device changes from the NVMe mode to a SD mode, the conventional SD-PCIe device loses/lacks the HMB feature. In SD mode, the conventional SD-PCIe device cannot use these HMB buffers, which the host 150 has provided for the SD Express cards in the NVMe mode. When dynamically switching from the NVMe mode to the SD mode, a significant amount of latency is involved in the host 150 flushing the metadata cached in HMB 204. This significant amount of latency is a major factor in the performance of the host 150, which is a deterrent to using dynamic switching from the NVMe mode to a SD mode.

FIG. 4 is a block diagram illustrating an initialization 400 of a SD mode of the data storage device 102 of FIG. 1, in accordance with various aspects of the disclosure. As illustrated in FIG. 4, the SD Host Software/HMB Abstraction Protocol layer 154 communicates with the NVMe host software 152 to access the HMB 204 (as described above in FIGS. 2 and 3).

Additionally, as illustrated in FIG. 4, the SD Host Software/HMB Abstraction Protocol layer 154 queries the NVMe host software 152 to retrieve active HMB information (e.g., a HMB descriptor list of the HMB 204) from the NVMe host software 152 (link 402). In response to the query, the SD Host Software/HMB Abstraction Protocol layer 154 receives the active HMB information from the NVMe host software 152 (link 404). For example, the SD Host Software/HMB Abstraction Protocol layer 154 receives a HMB descriptor list of the host memory address ranges for exclusive use by the data storage device controller 120.

After receiving the active HMB information, the SD Host Software/HMB Abstraction Protocol layer 154 sends one or more vendor specific commands to the data storage device controller 120 based on the active HMB information that is received by the SD Host Software/HMB Abstraction Protocol layer 154 (link 406). The one or more vendor specific commands may include an embedded form of the HMB descriptor list. The data storage device controller 120 responds to the SD Host Software/HMB Abstraction Protocol layer 154 in response to receiving the one or more vendor specific commands (link 408). For example, a response from the data storage device controller 120 to the SD Host Software/HMB Abstraction Protocol layer 154 is confirmation of receipt of the one or more vendor specific commands. The SD mode is a host initiated protocol. Therefore, the data storage device controller 120 specifies an intention to use any of the HMB buffer index for write or read only via a response to the periodic vendor specific command sent by the SD Host Software/HMB Abstraction Protocol layer 154.

The HMB information from the HMB 204 is maintained in a synchronized manner by the SD Host Software/HMB Abstraction Protocol layer 154 and the HMB Abstraction Protocol layer 164 of the data storage device controller 120. The SD protocol is based on host-initiated transactions. Therefore, the SD Host Software/HMB Abstraction Protocol layer 154 needs to query the firmware of the data storage device controller 120 for usage of the HMB 204 by sending one or more vendor specific commands at periodic interval or based on a group of SD commands received from the host 150. For example, a series of vendor specific commands may be sent to the firmware of the data storage device controller 120 to query the data storage device controller 120 on whether access of the HMB 204 by the data storage device controller 120 is required, what type of access (read/write) by the data storage device controller 120 is required, which HMB buffer is to be accessed, and transfer the data as requested by the data storage device controller 120.

As described above in FIGS. 2-4, the data storage device 102 is initialized with the host 150 in the NVMe mode and the HMB 204 is configured according to the NVMe protocol. When the data storage device 102 is switched to a SD mode, the active HMB information about the HMB 204 in the memory 206 is transferred to the command layer of the SD Host Software/HMB Abstraction Protocol layer 154. This transfer of the active HMB information to the command layer of the SD Host Software/HMB Abstraction Protocol layer 154 includes a transfer of a HMB descriptor list that is similar to the NVMe Descriptor list 160 to the command layer of the SD Host Software/HMB Abstraction Protocol layer 154. This transfer also represents an initialization of the HMB 204 when the data storage device is in the SD mode.

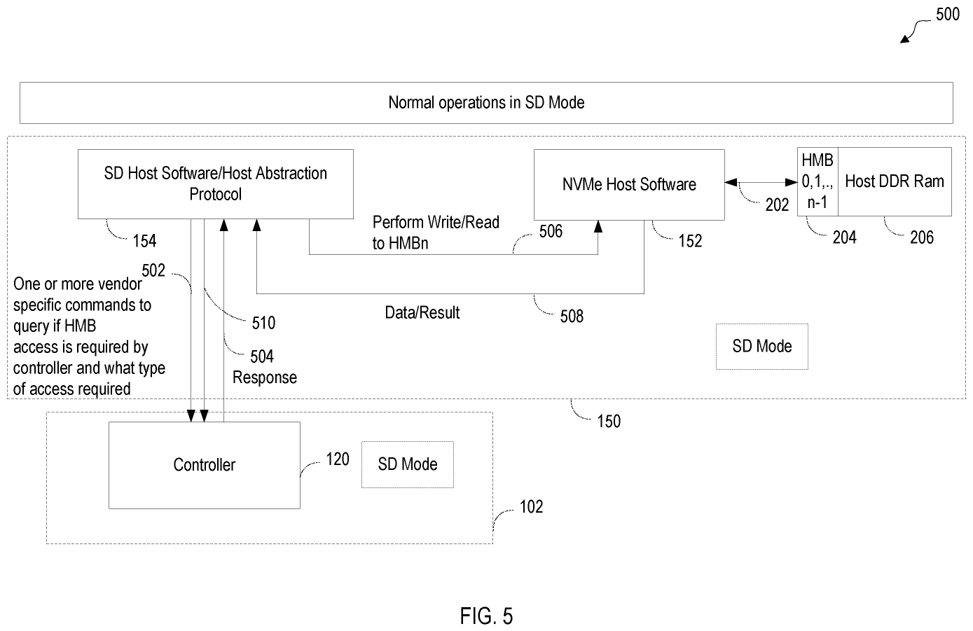

FIG. 5 is a block diagram illustrating normal operations 500 of the SD mode of the data storage device of FIG. 1 using the respective HMB Abstraction Protocol layers 154 and 164 of FIG. 1, in accordance with various aspects of the disclosure. As illustrated in FIG. 5, in response to the read/write operations, the SD host software/HMB Abstraction Protocol layer 154 queries the data storage device controller 120 using one or more vendor specific commands to request whether access to the HMB 204 is required and what type of access is required (link 502). The data storage device controller 120, with the HMB Abstraction Protocol layer 164, responds with an affirmative indication or a negative indication regarding whether access to the HMB 204 is required (link 504). The affirmative indication is indicative of the type of access that is required.

In response to receiving an affirmative indication, the SD host software/HMB Abstraction Protocol layer 154 performs a read/write operation on the HMB 204 by sending a HMB read/write command to the NVMe host software 152 (link 506). The NVMe host software 152 performs a read/write operation on the HMB 204 based on the read/write command from the SD host software/HMB Abstraction Protocol layer 154 (link 202). The NVMe host software 152 outputs the data/result from the read/write operation on the HMB 204 to the SD host software/HMB Abstraction Protocol layer 154 (link 508). The SD host software/HMB Abstraction Protocol layer 154 communicates the data/result from the read/write operation on the HMB 204 to the firmware of the data storage device controller 120 (link 510). In this way, the SD host software/HMB Abstraction Protocol layer 154 provides seamless access to buffers of the HMB 204 across the NVMe mode and the SD mode of operations of a SD-PCIe device by providing a translation service between the NVMe host software 152 and the firmware of the data storage device controller 120.

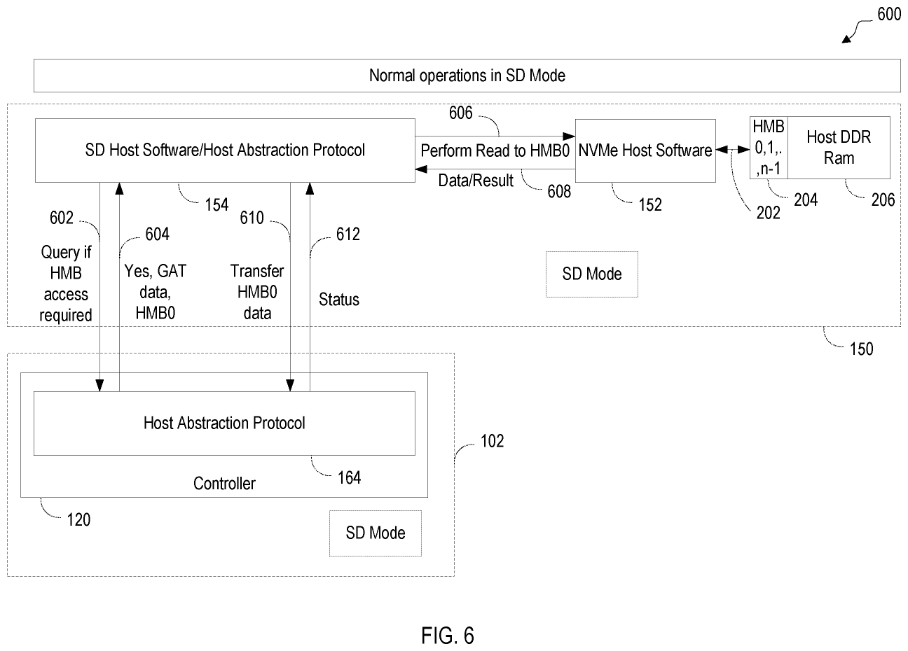

FIG. 6 is a block diagram illustrating a working example 600 of the SD mode of FIG. 5 of the data storage device of FIG. 1 using the respective HMB Abstraction Protocol layers 154 and 164 of FIG. 1, in accordance with various aspects of the disclosure. After initialization in the SD mode (e.g., transmitting a HMB descriptor list similar to the NVMe Descriptor list 160 to the data storage device controller 120), the host device 150 sends read commands to the data storage device 102, the SD host software/HMB Abstraction Protocol layer 154 determines that read commands are in a queue and is aware that read operations will be performed.

In response to the read operations, the SD host software/HMB Abstraction Protocol layer 154 queries the HMB Abstraction Protocol layer 164 of the data storage device controller 120 using one or more vendor specific commands to request whether access to the HMB 204 is required (link 602). The data storage device controller 120, with the HMB Abstraction Protocol layer 164, responds with an affirmative indication requesting a L2P buffer read from the HMB 204 (link 604).

In response to receiving an affirmative indication, the SD host software/HMB Abstraction Protocol layer 154 performs a read operation on the HMB 204 by sending a read command to the NVMe host software 152 to read one of the HMB buffer index from the initialized HMB descriptors (e.g., HMB0) (link 606). The NVMe host software 152 performs a read operation on buffer HMBO of the HMB 204 based on the HMB0 read command from the SD host software/HMB Abstraction Protocol layer 154 (link 202). The NVMe host software 152 outputs the data/result from the read operation on the buffer HMB0 of the HMB 204 to the SD host software/HMB Abstraction Protocol layer 154 (link 608). The SD host software/HMB Abstraction Protocol layer 154 transfers the data/result (i.e., the HMBO data) from the read operation on the buffer HMBO of the HMB 204 to the HMB Abstraction Protocol layer 164 of the data storage device controller 120 (link 610). The HMB Abstraction Protocol layer 164 of the data storage device controller 120 stores the data/result from the read/write operation on the HMB 204 in the SD HMB dataset 162 of the memory 124. In this way, the SD HMB dataset 162 may include a subset of the information (e.g., a subset of the control information described above) stored in the HMB 204 on the host device 150 that is accessible to the data storage device controller 120 when the data storage device controller 120 is operating in the SD mode.

Lastly, the data storage device controller 120, with the HMB Abstraction Protocol layer 164, responds with a status message to the SD host software/HMB Abstraction Protocol layer 154 in response to receiving the HMBO data from the SD host software/HMB Abstraction Protocol layer 154 (link 612). The status message indicates whether additional access of the HMB 204 is required by the data storage device controller 120.

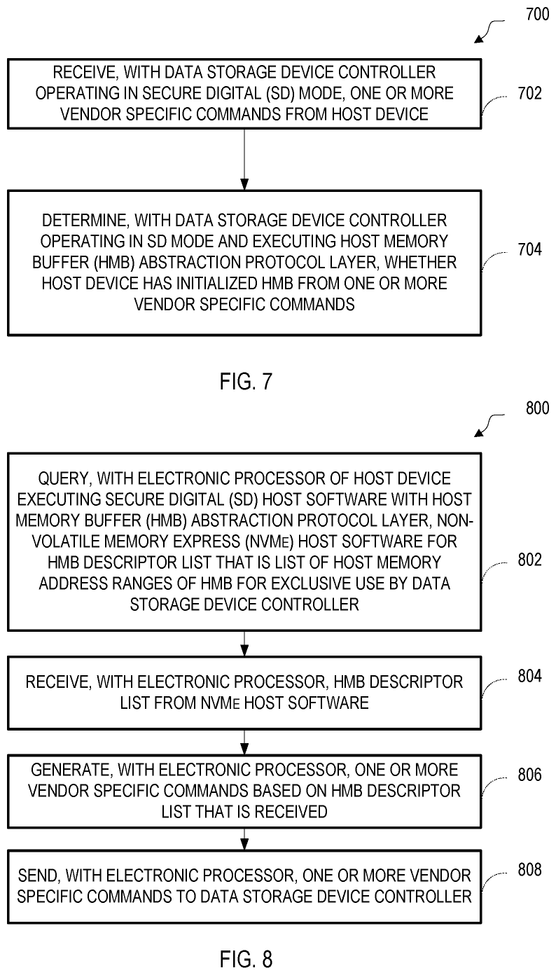

FIG. 7 is a flowchart illustrating an example method 700 of operating the data storage device 102 of FIG. 1, in accordance with some embodiments of the disclosure. FIG. 7 is described with respect to FIGS. 1 and 4.

As illustrated in FIG. 7, the method 700 includes receiving, with a data storage device controller operating in a SD mode, one or more vendor specific commands from a host device (at block 702). For example, the method 700 includes receiving, with the data storage device controller 120 operating in a SD mode, one or more vendor specific commands from the host device 150.

Additionally, the method 700 includes determining, with the data storage device controller operating in the SD mode and executing a HMB Abstraction Protocol layer, whether the host device has initialized a HMB from the one or more vendor specific commands (at block 704). For example, the method 700 includes determining, with the data storage device controller 120 operating in the SD mode and executing the HMB Abstraction Protocol layer 164, whether the host device 150 has initialized a HMB 204 from the one or more vendor specific commands by extracting a HMB descriptor list embedded in the one or more vendor specific commands. The HMB descriptor list is a list of HMB address ranges of the HMB 204 for exclusive use by the data storage device controller 120. The extraction of the HMB descriptor list from the one or more vendor specific commands indicates that the HMB 204 was already initialized when the data storage device controller 120 was operating in the NVMe mode. Moreover, the HMB descriptor list that is extracted may be used by the HMB Abstraction Protocol layer 164 to manage the HMB 204 in a way that is similar to the firmware of the data storage device controller 120 managing the HMB 204 with the NVMe Descriptor list 160 when operating in the NVMe mode as illustrated in FIG. 3. In other words, the extraction of the HMB descriptor list is a second initialization of the HMB 204 when the data storage device controller 120 is in the SD mode as illustrated in FIG. 4.

In some examples, the method 700 may further include requesting, with the data storage device controller 120 operating in the SD mode and executing the HMB Abstraction Protocol layer 164, a read operation on the HMB 204 in response to determining that the host device 150 has initialized the HMB 204. In these examples, requesting the read operation on the HMB 204 in response to determining that the host device 150 has initialized the HMB 204 may further include requesting a read of one of control data, tables, or Logical 2 Physical (L2P) mapping table information from the HMB 204 based on the HMB descriptor list, and the method 700 may further include receiving the one of the control data, the tables, or the L2P mapping table information from the HMB 204, and storing the one of the control data, the tables, or the L2P mapping table information in a memory of the data storage device controller 120. For example, the data storage device controller 120 stores the one of the control data, the tables, or the L2P mapping table information in the SD HMB dataset 162 of the memory 124. In this example, the SD HMB dataset 162 includes at least a subset of the information stored in the HMB 204. Additionally, in some examples, the SD HMB dataset 162 of the memory 124 also stores the HMB descriptor list that is similar to the NVMe Descriptor list 160 and extracted from the one or more vendor specific commands.

In some examples, the method 700 may further include requesting, with the data storage device controller 120 operating in the SD mode and executing the HMB Abstraction Protocol layer 164, a write operation on the HMB 204 in response to determining that the host device 150 has initialized the HMB 204. In these examples, requesting the write operation on the HMB 204 in response to determining that the host device 150 has initialized the HMB 204 may further include requesting a write of one of control data, tables, or Logical 2 Physical (L2P) mapping table information to the HMB 204, and the method 700 may further include receiving, with the data storage device controller 120 operating in the SD mode, a result of the write of the one of the control data, the tables, or the L2P mapping table information to the HMB 204.

Additionally, in some examples, the one or more vendor specific commands from the host device may be a query regarding whether access to the HMB 204 is required, whether read or write access to the HMB 204 is required, and whether access to a specific buffer of the HMB 204 is required, and the method 700 may further include determining, with the data storage device controller 120 operating in the SD mode and executing the HMB Abstraction Protocol layer 164, the query from the one or more vendor specific commands.

FIG. 8 is a flowchart illustrating an example method 800 of operating the host device 150 of FIG. 1, in accordance with some embodiments of the disclosure. FIG. 8 is described with respect to FIGS. 1 and 5.

As illustrated in FIG. 8, the method 800 includes querying, with an electronic processor of a host device executing a SD Host Software with a HMB Abstraction Protocol layer, a NVMe Host Software for a HMB descriptor list that is a list of host memory address ranges of a HMB for exclusive use by a data storage device controller (at block 802). For example, the method 800 includes querying, with an electronic processor of the host device 150 executing the SD Host Software/HMB Abstraction Protocol layer 154, the NVMe Host Software 152 for a HMB descriptor list that is a list of host memory address ranges of a HMB 204 for exclusive use by the data storage device controller 120.

The method 800 further includes receiving, with the electronic processor, the HMB descriptor list from the NVMe Host Software (at block 804). For example, the method 800 further includes receiving, with the electronic processor of the host device 150, the HMB descriptor list from the NVMe Host Software 152.

The method 800 further includes generating, with the electronic processor, one or more vendor specific commands based on the HMB descriptor list that is received (at block 806). For example, the method 800 further includes generating, with the electronic processor of the host device 150, one or more vendor specific commands based on the HMB descriptor list that is received.

The method 800 also includes sending, with the electronic processor, the one or more vendor specific commands to the data storage device controller (at block 808). For example, the method 800 also includes sending, with the electronic processor of the host device 150, the one or more vendor specific commands to the data storage device controller 120 with a HMB descriptor list embedded in the one or more vendor specific commands.

In some examples, the method 800 may further include receiving, with the electronic processor, a read operation on the HMB 204 from the data storage device controller 120 in response to sending the one or more vendor specific commands to the data storage device controller 120. In these examples, receiving the read operation on the HMB 204 from the data storage device controller 120 may further include receiving a request to read of one of control data, tables, or Logical 2 Physical (L2P) mapping table information from the HMB 204, and the method 800 may further include sending, with the electronic processor, a read command to the HMB 204 to read the one of the control data, the tables, or the L2P mapping table information from the HMB 204, receiving the one of the control data, the tables, or the L2P mapping table information that is read from the HMB 204, and outputting the one of the control data, the tables, or the L2P mapping table information that is read to the data storage device controller 120.

In some examples, the method 800 may further include receiving a write operation on the HMB 204 from the data storage device controller 120 in response to sending the one or more vendor specific commands to the data storage device controller 120. In these examples, receiving the write operation on the HMB 204 from the data storage device controller 120 may further include receiving a request to write one of control data, tables, or Logical 2 Physical (L2P) mapping table information to the HMB 204, and the method 800 may further include writing, with the electronic processor, the one of the control data, the tables, or the L2P mapping table information to the HMB 204, and outputting, with the electronic processor, a result to the data storage device controller 120, the result indicating a status of the write of the one of the control data, the tables, or the L2P mapping table information to the HMB 204.

Additionally, in some examples, the one or more vendor specific commands may be a query regarding whether access to the HMB 204 is required by the data storage device controller 120, whether read or write access to the HMB 204 is required by the data storage device controller 120, and whether access to a specific buffer of the HMB 204 is required by the data storage device controller 120.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

In particular, the above description is with respect to a HMB that is actively managed by a host device. However, it will be readily apparent to one skilled in the art that these specific details are merely exemplary and not intended to limit the scope of this application because the above description is also applicable to a memory buffer that is actively managed by a data storage device. In this alternative embodiment, the HMB is hosted by the host device, but the data storage device actively queries the host device, and consequently, actively manages the HMB. In this alternative embodiment, the data storage device may actively query the host device to perform read/write operations on the HMB without receiving vendor specific commands as described above.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A data storage device controller, comprising:
memory; and
an electronic processor communicatively coupled to the memory,
wherein the memory includes a Secure Digital (SD) Host Memory Buffer (HMB) dataset and a HMB Abstraction Protocol layer that maintains the SD HMB dataset.

2. The data storage device controller of claim 1, wherein the memory further includes a Non-Volatile Memory Express (NVMe) HMB Descriptor list that is separate and distinct from the SD HMB dataset, the NVMe HMB Descriptor list is a list of host memory address ranges of a HMB of a host device for exclusive use by the data storage device controller.

3. The data storage device controller of claim 1, wherein the electronic processor is configured to
receive one or more vendor specific commands from a host device, and
determine, with the HMB Abstraction Protocol layer, whether the host device has initialized a HMB from the one or more vendor specific commands.

4. The data storage device controller of claim 3, wherein the electronic processor is further configured to request, with the HMB Abstraction Protocol layer, a read operation on the HMB in response to determining that the host device has initialized the HMB.

5. The data storage device controller of claim 4, wherein, to request, with the HMB Abstraction Protocol layer, the read operation on the HMB in response to determining that the host device has initialized the HMB, the electronic processor is further configured to request, with the HMB Abstraction Protocol layer, a read of one of control data, tables, or Logical 2 Physical (L2P) mapping table information from the HMB, and wherein the electronic processor is further configured to:
receive the one of the control data, the tables, or the L2P mapping table information from the HMB, and
store the one of the control data, the tables, or the L2P mapping table information in the memory.

6. The data storage device controller of claim 3, wherein the electronic processor is further configured to request, with the HMB Abstraction Protocol layer, a write operation on the HMB in response to determining that the host device has initialized the HMB.

7. The data storage device controller of claim 6, wherein, to request, with the HMB Abstraction Protocol layer, the write operation on the HMB in response to determining that the host device has initialized the HMB, the electronic processor is further configured to request, with the HMB Abstraction Protocol layer, a write of one of control data, tables, or Logical 2 Physical (L2P) mapping table information to the HMB, and wherein the electronic processor is further configured to receive a result from the host device, the result indicating a status of the write of the one of the control data, the tables, or the L2P mapping table information to the HMB.

8. The data storage device controller of claim 3, wherein the one or more vendor specific commands from the host device are a query regarding whether access to the HMB is required, whether read or write access to the HMB is required, and whether access to a specific buffer of the HMB is required, and
wherein the electronic processor is configured to determine, with the HMB Abstraction Protocol layer, the query from the one or more vendor specific commands.

9. A method, comprising:
receiving, with a data storage device controller operating in a Secure Digital (SD) mode, one or more vendor specific commands from a host device; and
determining, with the data storage device controller operating in the SD mode and executing a HMB Abstraction Protocol layer, whether the host device has initialized a HMB from the one or more vendor specific commands.

10. The method of claim 9, further comprising:
requesting, with the data storage device controller operating in the SD mode and executing the HMB Abstraction Protocol layer, a read operation on the HMB in response to determining that the host device has initialized the HMB.

11. The method of claim 10, wherein requesting the read operation on the HMB in response to determining that the host device has initialized the HMB further includes requesting a read of one of control data, tables, or Logical 2 Physical (L2P) mapping table information from the HMB, and
wherein the method further includes
receiving the one of the control data, the tables, or the L2P mapping table information from the HMB; and
storing the one of the control data, the tables, or the L2P mapping table information in a memory of the data storage device controller.

12. The method of claim 9, further comprising:
requesting, with the data storage device controller operating in the SD mode and executing the HMB Abstraction Protocol layer, a write operation on the HMB in response to determining that the host device has initialized the HMB.

13. The method of claim 12, wherein requesting the write operation on the HMB in response to determining that the host device has initialized the HMB further includes requesting a write of one of control data, tables, or Logical 2 Physical (L2P) mapping table information to the HMB, and
wherein the method further includes receiving, with the data storage device controller operating in the SD mode, a result of the write of the one of the control data, the tables, or the L2P mapping table information to the HMB.

14. The method of claim 9, wherein the one or more vendor specific commands from the host device are a query regarding whether access to the HMB is required, whether read or write access to the HMB is required, and whether access to a specific buffer of the HMB is required, and
wherein the method further includes determining, with the data storage device controller operating in the SD mode and executing the HMB Abstraction Protocol layer, the query from the one or more vendor specific commands.

15. A host device, comprising:
memory; and
an electronic processor communicatively coupled to the memory,
wherein the memory includes
a Non-Volatile Memory Express (NVMe) Host Software, and
a Secure Digital (SD) Host Software with a Host Memory Buffer (HMB) Abstraction Protocol layer.

16. The host device of claim 15, wherein, when executing the NVMe Host Software and the SD Host Software with the HMB Abstraction Protocol layer, the electronic processor is configured to
query the NVMe Host Software for a HMB descriptor list that is a list of host memory address ranges of a HMB for exclusive use by a data storage device controller,
receive the HMB descriptor list from the NVMe Host Software,
generate one or more vendor specific commands based on the HMB descriptor list that is received, and
send the one or more vendor specific commands to the data storage device controller.

17. The host device of claim 16, wherein the electronic processor is further configured to receive a read operation on the HMB from the data storage device controller in response to sending the one or more vendor specific commands to the data storage device controller.

18. The host device of claim 17, wherein, to receive the read operation on the HMB from the data storage device controller, the electronic processor is further configured to receive a request to read of one of control data, tables, or Logical 2 Physical (L2P) mapping table information from the HMB, and wherein, when executing the NVMe Host Software and the SD Host Software with the HMB Abstraction Protocol layer, the electronic processor is further configured to:
send a read command to the HMB to read the one of the control data, the tables, or the L2P mapping table information from the HMB,
receive the one of the control data, the tables, or the L2P mapping table information that is read from the HMB, and
output the one of the control data, the tables, or the L2P mapping table information that is read to the data storage device controller.

19. The host device of claim 16, wherein the electronic processor is further configured to receive a write operation on the HMB from the data storage device controller in response to sending the one or more vendor specific commands to the data storage device controller.

20. The host device of claim 19, wherein, to receive the write operation on the HMB from the data storage device controller, the electronic processor is further configured to receive a request to write one of control data, tables, or Logical 2 Physical (L2P) mapping table information to the HMB, and
wherein the electronic processor, when executing the NVMe Host Software and the SD Host Software with the HMB Abstraction Protocol layer, is further configured to
write the one of the control data, the tables, or the L2P mapping table information to the HMB, and
output a result to the data storage device controller, the result indicating a status of the write of the one of the control data, the tables, or the L2P mapping table information to the HMB.

21. The host device of claim 16, wherein the one or more vendor specific commands are a second query regarding whether access to the HMB is required by the data storage device controller, whether read or write access to the HMB is required by the data storage device controller, and whether access to a specific buffer of the HMB is required by the data storage device controller.

22. A method, comprising:
querying, with an electronic processor of a host device executing a Secure Digital (SD) Host Software with a Host Memory Buffer (HMB) Abstraction Protocol layer, a Non-Volatile Memory Express (NVMe) Host Software for a HMB descriptor list that is a list of host memory address ranges of a HMB for exclusive use by a data storage device controller;
receiving, with the electronic processor, the HMB descriptor list from the NVMe Host Software;
generating, with the electronic processor, one or more vendor specific commands based on the HMB descriptor list that is received; and
sending, with the electronic processor, the one or more vendor specific commands to the data storage device controller.

23. The method of claim 22, further comprising:
receiving, with the electronic processor, a read operation on the HMB from the data storage device controller in response to sending the one or more vendor specific commands to the data storage device controller.

24. The method of claim 23, wherein receiving the read operation on the HMB from the data storage device controller further includes receiving a request to read of one of control data, tables, or Logical 2 Physical (L2P) mapping table information from the HMB, and
wherein the method further includes
sending, with the electronic processor, a read command to the HMB to read the one of the control data, the tables, or the L2P mapping table information from the HMB,
receiving the one of the control data, the tables, or the L2P mapping table information that is read from the HMB, and
outputting the one of the control data, the tables, or the L2P mapping table information that is read to the data storage device controller.

25. The method of claim 22, further comprising:
receiving a write operation on the HMB from the data storage device controller in response to sending the one or more vendor specific commands to the data storage device controller.

26. The method of claim 25, wherein receiving the write operation on the HMB from the data storage device controller further includes receiving a request to write one of control data, tables, or Logical 2 Physical (L2P) mapping table information to the HMB, and
wherein the method further includes
writing, with the electronic processor, the one of the control data, the tables, or the L2P mapping table information to the HMB, and
outputting, with the electronic processor, a result to the data storage device controller, the result indicating a status of the write of the one of the control data, the tables, or the L2P mapping table information to the HMB.

27. The method of claim 22, wherein the one or more vendor specific commands are a query regarding whether access to the HMB is required by the data storage device controller, whether read or write access to the HMB is required by the data storage device controller, and whether access to a specific buffer of the HMB is required by the data storage device controller.

28. An apparatus, comprising:
means for receiving one or more vendor specific commands from a host device; and
means for determining whether the host device has initialized a Host Memory Buffer (HMB) from the one or more vendor specific commands.

29. An apparatus, comprising:
means for querying a Non-Volatile Memory Express (NVMe) Host Software for a Host Memory Buffer (HMB) descriptor list that is a list of host memory address ranges of a Host Memory Buffer (HMB) for exclusive use by a data storage device controller;
means for receiving the HMB descriptor list from the NVMe Host Software;
means for generating one or more vendor specific commands based on the HMB descriptor list that is received; and
means for sending the one or more vendor specific commands to the data storage device controller.

30. A system, comprising:
a data storage device controller of claim 1; and
a host device including
memory; and
an electronic processor communicatively coupled to the memory,
wherein the memory includes
a Non-Volatile Memory Express (NVMe) Host Software, and
a Secure Digital (SD) Host Software with a Host Memory Buffer (HMB) Abstraction Protocol layer,
wherein the data storage device controller and the host device are multi-protocol devices,
wherein a first protocol is the Non-Volatile Memory Express (NVMe) protocol, and
wherein a second protocol is a second host interface protocol that is different from the NVMe protocol.
